(19) United States
(12) Patent Application Publication
(10) Pub. No.: US 2013/0215368 A1
(43) Pub. Date: Aug. 22, 2013

(54) LIQUID CRYSTAL OPTICAL APPARATUS AND IMAGE DISPLAY DEVICE

(71) Applicants: Ayako Takagi, Kanagawa-ken (JP); Shinichi Uehara, Tokyo (JP); Masako Kashiwagi, Kanagawa-ken (JP); Masahiro Baba, Kanagawa-ken (JP)

(72) Inventors: Ayako Takagi, Kanagawa-ken (JP); Shinichi Uehara, Tokyo (JP); Masako Kashiwagi, Kanagawa-ken (JP); Masahiro Baba, Kanagawa-ken (JP)

(21) Appl. No.: 13/606,213

(22) Filed: Sep. 7, 2012

(30) Foreign Application Priority Data
Feb. 16, 2012 (JP) 2012-031697

(51) Int. Cl. G02F 1/1343

(52) U.S. Cl. 349/138

(57) ABSTRACT

According to one embodiment, a liquid crystal optical apparatus includes first and second substrate units and a liquid crystal layer. The first substrate unit includes a first substrate, first electrodes, and electrode pairs. The first electrodes extend in a first direction. The electrode pairs are provided between the first electrodes on the first major surface. Each electrode pair includes second and third electrodes, and an insulating layer provided between the second and third electrodes. The second substrate unit includes a second substrate and an opposing electrode. The liquid crystal layer is provided between the first and second substrate units. A distance from a position of a first pair of the electrode pairs to a position of a second pair most proximal to the first pair is shorter than a distance from a central axis between the first electrodes to the position of the first pair.

### CROSS-REFERENCE TO RELATED APPLICATIONS

This application is based upon and claims the benefit of priority from the prior Japanese Patent Application No. 2012-031697, filed on Feb. 16, 2012; the entire contents of which are incorporated herein by reference.

### FIELD

Embodiments described herein relate generally to a liquid crystal optical apparatus and an image display device.

### BACKGROUND

A liquid crystal optical apparatus is known that utilizes the birefringence of liquid crystal molecules to change the distribution of the refractive index according to the application of a voltage. There is a stereoscopic image display device that combines such a liquid crystal optical apparatus with an image display unit.

Such a stereoscopic image display device switches between a state in which an image displayed on the image display unit is caused to be incident as-is on the eye of a human viewer, and a state in which the image displayed on the image display unit is caused to be incident on the eye of the human viewer as multiple parallax images by changing the distribution of the refractive index of the liquid crystal optical apparatus. Thereby, a two-dimensional display operation and a three-dimensional image display operation are realized. Also, technology is known that modifies the path of the light by utilizing the optical principle of a Fresnel zone plate. High display quality is desirable for such display devices.

### BRIEF DESCRIPTION OF THE DRAWINGS

FIG. 1 is a schematic cross-sectional view showing the configuration of a liquid crystal optical apparatus according to a first embodiment;

FIG. 2 is a schematic view showing the configuration of the liquid crystal optical apparatus according to the first embodiment;

FIG. 3A and FIG. 3B are schematic views showing characteristics of the liquid crystal optical apparatus according to the first embodiment;

FIG. 4 is a schematic cross-sectional view showing the configuration of another liquid crystal optical apparatus according to the first embodiment;

FIG. 5 is a schematic cross-sectional view showing the configuration of another liquid crystal optical apparatus according to the first embodiment;

FIG. 6 is a schematic cross-sectional view showing the configuration of another liquid crystal optical apparatus according to the first embodiment;

FIG. 7 is a schematic cross-sectional view showing the configuration of another liquid crystal optical apparatus according to the first embodiment;

FIG. 8 is a schematic cross-sectional view showing the configuration of another liquid crystal optical apparatus according to the first embodiment;

FIG. 9 is a schematic view showing characteristics of another liquid crystal optical apparatus according to the first embodiment;

FIG. 10 is a graph showing characteristics of liquid crystal optical apparatuses;

FIG. 11 is a schematic cross-sectional view showing the configuration of a liquid crystal optical apparatus according to a second embodiment; and

FIG. 12 is a schematic cross-sectional view showing the configuration of another liquid crystal optical apparatus according to the second embodiment.

### DETAILED DESCRIPTION

According to one embodiment, a liquid crystal optical apparatus includes a first substrate unit, a second substrate unit and a liquid crystal layer. The first substrate unit includes a first substrate, a plurality of first electrodes, and a plurality of electrode pairs. The first substrate has a first major surface. The first electrodes are provided on the first major surface. The first electrodes extend in a first direction and are arranged in a second direction orthogonal to the first direction. The electrode pairs are provided between the first electrodes on the first major surface. The electrode pairs are arranged in the second direction. Each electrode pair includes a second electrode extending in the first direction, a third electrode extending in the first direction, and an insulating layer provided between the second electrode and the third electrode. The second electrode and the third electrode are overlapped partly each other when projected onto a plane parallel to the first substrate. The second substrate unit includes a second substrate having a second major surface opposing the first major surface, and an opposing electrode provided on the second major surface. The liquid crystal layer is provided between the first substrate unit and the second substrate unit. A first distance along the second direction from a position of a first pair of the electrode pairs to a position of a second pair most proximal to the first pair and disposed between the first pair and one electrode of two most proximal first electrodes is shorter than a distance along the second direction from a central axis between the first electrodes to the position of the first pair. The central axis is parallel to the first direction to pass through a midpoint of a line segment connecting centers of the two most proximal first electrodes in the second direction.

According to one embodiment, an image display device includes a liquid crystal optical apparatus and an image display unit. The image display unit includes a display unit. The display unit is stacked with the liquid crystal optical apparatus, and configured to cause a light including image information to be incident on the liquid crystal layer. The liquid crystal optical apparatus includes a first substrate unit, a second substrate unit and a liquid crystal layer. The first substrate unit includes a first substrate, a plurality of first electrodes, and a plurality of electrode pairs. The first substrate has a first major surface. The first electrodes are provided on the first major surface. The first electrodes extend in a first direction and are arranged in a second direction orthogonal to the first direction. The electrode pairs are provided between the first electrodes on the first major surface. The electrode pairs are arranged in the second direction. Each electrode pair includes a second electrode extending in the first direction, a third electrode extending in the first direction, and an insulating layer provided between the second electrode and the third electrode. The second electrode and the third electrode are overlapped partly each other when projected onto a plane parallel to the first substrate. The second substrate unit includes a second substrate having a second major surface opposing the first major surface, and an opposing electrode provided on the second major surface. The liquid crystal layer is provided between the first substrate unit and the second substrate unit. A first distance along the second direction from a first electrode pair of the electrode pairs to a second pair most proximal to the first pair is shorter than a distance along the second direction from a central axis between the first electrodes to the first pair. The central axis is parallel to the first direction to pass through a midpoint of a line segment connecting centers of the two most proximal first electrodes in the second direction.

Various embodiments will be described hereinafter with reference to the accompanying drawings.

The drawings are schematic or conceptual; and the relationships between the thicknesses and the widths of portions, the proportions of the sizes between portions, etc., are not necessarily the same as the actual values thereof. The dimensions and/or the proportions may be illustrated differently between the drawings, even for identical portions.

In the specification and the drawings of the application, components similar to those described in regard to a drawing thereinabove are marked with like reference numerals, and a detailed description is omitted as appropriate.

### First Embodiment

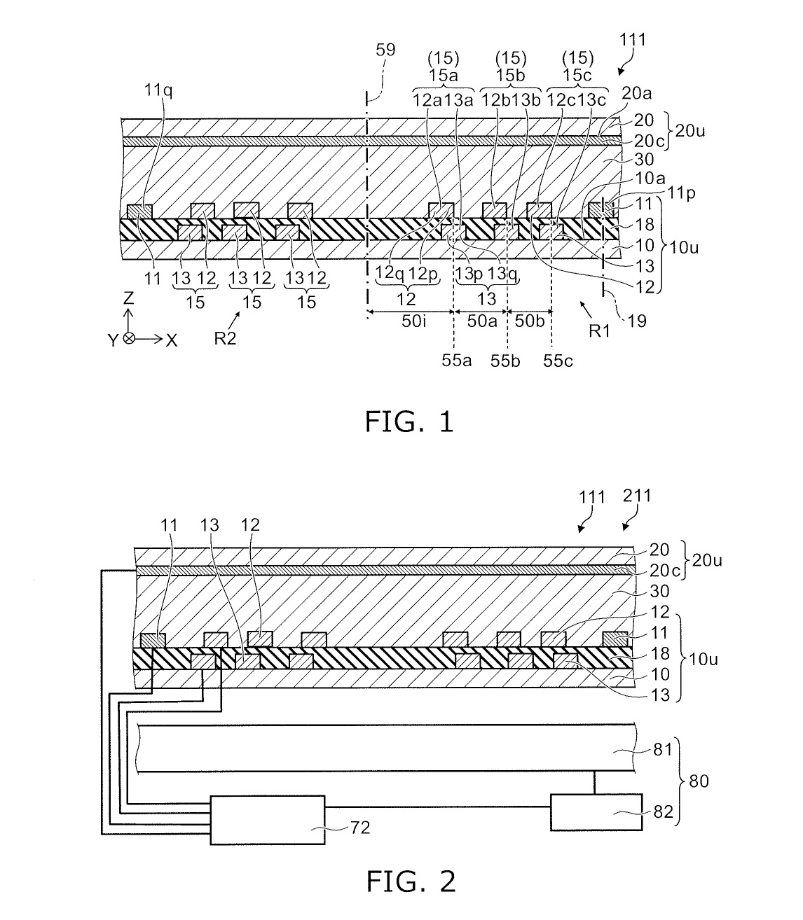

FIG. 1 is a schematic cross-sectional view illustrating the configuration of a liquid crystal optical apparatus according to a first embodiment.

As shown in FIG. 1, the liquid crystal optical apparatus 111 according to the embodiment includes a first substrate unit 10u, a second substrate unit 20u, and a liquid crystal layer 30.

The first substrate unit 10u includes a first substrate 10, multiple first electrodes 11, and multiple electrode pairs 15. The first substrate 10 has a first major surface 10a. The multiple first electrodes 11 are provided on the first major surface 10a. Each of the multiple first electrodes 11 extends in a first direction. The multiple first electrodes 11 are arranged along a second direction. The second direction is orthogonal to the first direction.

Herein, the first direction is a Y-axis direction. The second direction is an X-axis direction. A direction perpendicular to the X-axis direction and the Y-axis direction is a Z-axis direction.

The multiple electrode pairs 15 are provided in each region between the multiple first electrodes 11 on the first major surface 10a. The multiple electrode pairs 15 are arranged in the second direction (the X-axis direction).

Each of the multiple electrode pairs 15 includes a second electrode 12 extending in the first direction (the Y-axis direction), a third electrode 13 extending in the first direction, and an insulating layer 18. The insulating layer 18 is provided between the second electrode 12 and the third electrode 13. The insulating layer 18 may be continuous between the multiple electrode pairs 15. In this example, the insulating layer 18 extends between the first substrate 10 and the first electrodes 11.

Two of the multiple first electrodes 11 are illustrated in FIG. 1. The number of the multiple first electrodes 11 is arbitrary.

Two most proximal first electrodes 11 of the multiple first electrodes 11 will now be focused upon. A central axis 59 is between the most proximal first electrodes 11. The central axis 59 passes through a midpoint of a line segment connecting the X-axis direction centers of the two most proximal first electrodes 11. The central axis 59 is parallel to the Y-axis direction.

One electrode 11p of the two most proximal first electrodes 11 will now be focused upon. A position 19 of the electrode 11p is the position of the X-axis direction center of the electrode 11.

The region of the first major surface 10a between the central axis 59 and the one electrode 11p of the two most proximal first electrodes 11 is a first region R1. The region of the first major surface 10a between the central axis 59 and the other electrode 11q of the two most proximal first electrodes 11 is a second region R2. The direction from the central axis 59 toward the electrode 11p is the +X direction. The direction from the central axis 59 toward the electrode 11q corresponds to the −X direction.

Three electrode pairs 15 are provided in the first region R1 in this example. The three electrode pairs 15 include a first electrode pair 15a, a second electrode pair 15b, and a third electrode pair 15c. The first electrode pair 15a, the second electrode pair 15b, and the third electrode pair 15c are arranged in this order along the +X direction. The first electrode pair 15a includes a second electrode 12a and a third electrode 13a. The second electrode pair 15b includes a second electrode 12b and a third electrode 13b. The third electrode pair 15c includes a second electrode 12c and a third electrode 13c.

The multiple electrode pairs 15 are separated from each other when projected onto the X-Y plane. A region where electrodes are not provided exists between the electrode pairs 15. In the embodiment, other electrodes may be further provided between the electrode pairs 15.

In one of the electrode pairs 15, the second electrode 12 has a first superimposed portion 12p overlaying the third electrode 13 and a first non-superimposed portion 12q not overlaying the third electrode 13 when projected onto a plane (the X-Y plane) parallel to the first direction and the second direction. In the one of the electrode pairs 15, the third electrode 13 has a second superimposed portion 13p overlaying the second electrode 12 and a second non-superimposed portion 13q not overlaying the second electrode 12 when projected onto the X-Y plane.

Although the first superimposed portion 12p, the first non-superimposed portion 12q, the second superimposed portion 13p, and the second non-superimposed portion 13q are marked with reference numerals for the first electrode pair 15a in FIG. 1, the first superimposed portion 12p, the first non-superimposed portion 12q, the second superimposed portion 13p, and the second non-superimposed portion 13q are provided also in the other electrode pairs 15 such as the second electrode pair 15b, the third electrode pair 15c, etc.

In the liquid crystal optical apparatus 111, the first superimposed portion 12p is disposed between the second superimposed portion 13p and the liquid crystal layer 30 for each of the multiple electrode pairs 15 included in the first region R1. The position of the second electrode 12 is shifted in the X-axis direction with respect to the position of the third electrode 13. Specifically, in one of the electrode pairs 15, the distance between the second non-superimposed portion 13q and the central axis 59 is longer than the distance between the first non-superimposed portion 12q and the central axis 59. In other words, in the one of the electrode pairs 15, the second electrode 12 is more proximal to the central axis 59 than is the third electrode 13.

The disposition of the electrode pairs 15 in the second region R2 has substantially line symmetry with the central axis 59 as an axis of symmetry. However, this may not be a rigorous line symmetry. For example, a micro asymmetry may be introduced based on the distribution of the arrangement of the liquid crystal layer 30 (e.g., the pretilt angle, etc.). Although the configuration and the characteristics of the first region R1 are described hereinbelow, the configuration and the characteristics of the second region R2 also are similar.

The second substrate unit 20u includes a second substrate 20 and an opposing electrode 20c. The second substrate 20 has a second major surface 20a opposing the first major surface 10a. The opposing electrode 20c is provided on the second major surface 20a. The opposing electrode 20c has a portion overlaying the first electrodes 11 and the electrode pairs 15 when projected onto the X-Y plane. For example, the opposing electrode 20c extends in the X-Y plane.

The first substrate 10, the first electrodes 11, the second electrodes 12, the third electrodes 13, the insulating layer 18, the second substrate 20, and the opposing electrode 20c are transmissive with respect to light, and specifically, are transparent.

The first substrate 10 and the second substrate 20 may include, for example, a transparent material such as glass, a resin, etc. The first substrate 10 and the second substrate 20 have plate configurations or sheet configurations. For example, the thicknesses of the first substrate 10 and the second substrate 20 are not less than 50 micrometers (μm) and not more than 2000 μm. However, the thicknesses are arbitrary.

For example, the first electrode 11, the second electrode 12, the third electrode 13, and the opposing electrode 20c include an oxide including at least one (one type) of element selected from the group consisting of In, Sn, Zn, and Ti. These electrodes may include, for example, ITO. For example, at least one selected from In₂O₃ and SnO₃ may be used. For example, the thicknesses of these electrodes may be about 200 nanometers (nm) (e.g., not less than 100 nm and not more than 350 nm). For example, the thicknesses of the electrodes are set to be thicknesses for which high transmittance with respect to visible light is obtained.

For example, the disposition pitch of the first electrodes 11 (the distance between the X-axis direction centers of the most proximal first electrodes 11) is not less than 10 μm and not more than 1000 μm. The disposition pitch is set to match the desired specifications (the characteristics of the gradient index lens described below).

For example, the lengths (the widths) of the first electrode 11, the second electrode 12, and the third electrode 13 along the X-axis direction are not less than 5 μm and not more than 300 μm.

The insulating layer 18 may include, for example, SiO₂, etc. For example, the thickness of the insulating layer 18 is not less than 100 nm and not more than 1000 nm. Thereby, appropriate insulative properties and high transmittance are obtained.

The liquid crystal layer 30 is provided between the first substrate unit 10u and the second substrate unit 20u. The liquid crystal layer 30 includes a liquid crystal material. The liquid crystal material may include a nematic liquid crystal (having a nematic phase at the temperature at which the liquid crystal optical apparatus 111 is used). The liquid crystal material has a positive dielectric anisotropy or a negative dielectric anisotropy. For example, in the case of the positive dielectric anisotropy, the initial arrangement of the liquid crystal of the liquid crystal layer 30 (when a voltage is not applied to the liquid crystal layer 30) is substantially a horizontal alignment (parallel alignment). In the case of the negative dielectric anisotropy, the initial arrangement of the liquid crystal of the liquid crystal layer 30 is substantially a vertical alignment. For the horizontal alignment in the specification of the application, the angle (the pretilt angle) between the director of the liquid crystal (the long axis of the liquid crystal molecules) and the X-Y plane is not less than 0° and not more than 30°. For example, for the vertical alignment, the pretilt angle is not less than 60° and not more than 90°. The director of the liquid crystal of at least one selected from the initial arrangement and the arrangement during the voltage application has a component parallel to the X-axis direction.

Herein, the case is described where the dielectric anisotropy of the liquid crystal included in the liquid crystal layer 30 is positive and the initial arrangement is substantially the horizontal alignment.

In the case of the substantially horizontal alignment, the director is substantially parallel to the X-axis direction in the initial arrangement when projected onto the X-Y plane. For example, the angle (the absolute value of the angle) between the director and the X-axis direction is not more than 10 degrees when projected onto the X-Y plane. The orientation direction of the liquid crystal layer 30 proximal to the first substrate unit 10u is antiparallel to the orientation direction of the liquid crystal layer 30 proximal to the second substrate unit 20u. In other words, the initial alignment is not a splay alignment.

The first substrate unit 10u may further include an alignment film (not illustrated). The first electrodes 11 and the electrode pairs 15 are disposed between the first substrate 10 and the alignment film of the first substrate unit 10u. The second substrate unit 20u may further include an alignment film (not illustrated). The opposing electrode 20c is disposed between the second substrate 20 and the alignment film of the second substrate unit 20u. These alignment films may include, for example, polyimide. For example, the initial arrangement of the liquid crystal layer 30 is obtained by performing rubbing of the alignment films. The direction of the rubbing of the first substrate unit 10u is antiparallel to the rubbing direction of the second substrate unit 20u. The initial alignment may be obtained by performing light irradiation of the alignment films.

The liquid crystal alignment of the liquid crystal layer 30 is changed by applying voltages between the opposing electrode 20c and the first electrodes 11, between the opposing electrode 20c and the second electrodes 12, and between the opposing electrode 20c and the third electrodes 13. A refractive index distribution is formed in the liquid crystal layer 30 according to this change; and the travel direction of the light that is incident on the liquid crystal optical apparatus 111 is changed by the refractive index distribution. The change of the travel direction of the light is mainly based on the refraction effect.

FIG. 2 is a schematic view illustrating the configuration of the liquid crystal optical apparatus according to the first embodiment.

FIG. 2 also shows an example of the state of use of the liquid crystal optical apparatus 111. The liquid crystal optical apparatus 111 is used with an image display unit 80. The image display device 211 according to the embodiment includes any of the liquid crystal optical apparatuses according to the embodiment (in this example, the liquid crystal optical apparatus 111) and the image display unit 80. Any display device may be used as the image display unit 80. For example, a liquid crystal display device, an organic EL display device, a plasma display, etc., may be used.

The image display unit 80 includes a display unit 81. The display unit 81 is stacked with the liquid crystal optical apparatus 111. The display unit 81 causes the light including image information to be incident on the liquid crystal layer 30. In this example, the light enters the liquid crystal layer 30 via the first substrate unit 10u and is emitted to the outside via the second substrate unit 20u. The image display unit 80 may further include a display drive unit 82 that drives the display unit 81. The display unit 81 produces light that is modulated based on the signal supplied to the display unit 81 from the display drive unit 82. As described below, the liquid crystal optical apparatus 111 has an operating state that modifies the optical path and an operating state that substantially does not modify the optical path. For example, the image display device 211 provides a three-dimensional display by the light being incident on the liquid crystal optical apparatus 111 in the operating state that modifies the optical path. For example, the image display device 211 provides a two-dimensional image display in the operating state that substantially does not modify the optical path.

As shown in FIG. 2, the liquid crystal optical apparatus 111 may further include a drive unit 72. The drive unit 72 may be connected to the display drive unit 82 by a wired or wireless method (an electrical method, an optical method, etc.). The image display device 211 may further include a control unit (not illustrated) that controls the drive unit 72 and the display drive unit 82.

The drive unit 72 is electrically connected to the first electrodes 11, the second electrodes 12, the third electrodes 13, and the opposing electrode 20c.

An example of the operation of the drive unit 72 will now be described relating to a configuration such as that of the liquid crystal optical apparatus 111 (a configuration in which the first superimposed portion 12p is disposed between the second superimposed portion 13p and the liquid crystal layer 30 and the second non-superimposed portion 13q is more distal to the central axis than is the first non-superimposed portion 12q in the first region R1).

In this configuration, the drive unit 72 applies a first voltage V1 between the opposing electrode 20c and the first electrodes 11, applies a second voltage V2 between the opposing electrode 20c and the second electrodes 12, and applies a third voltage V3 between the opposing electrode 20c and the third electrodes 13. For convenience herein, the state in which the potential is the same (is zero volts) between two electrodes also is taken to be included in the state in which the voltage is applied.

The absolute value of the first voltage V1 is greater than the absolute value of the third voltage V3. The absolute value of the second voltage V2 is less than the absolute value of the third voltage V3. That is, the absolute value of the first voltage V1 is greater than the absolute value of the second voltage V2 and the greater than the absolute value of the third voltage V3.

The first voltage V1, the second voltage V2, and the third voltage V3 may be direct-current voltages or alternating current voltages. In the case of alternating current voltages, the effective value of the first voltage V1 is greater than the effective value of the third voltage V3; and the effective value of the second voltage is less than the effective value of the third voltage V3.

The potential of the opposing electrode 20c may be fixed; and the potential of at least one selected from the first electrode 11, the second electrode 12, and the third electrode 13 may be changed as alternating current. The absolute value (the effective value) of the third voltage V3 can be relatively small by changing the potential of the opposing electrode 20c as alternating current and supplying a voltage having the same polarity as the polarity of the change to the third electrode 13. The absolute value (the effective value) of the first voltage V1 can be relatively large by supplying a voltage having a polarity opposite to the polarity of the change of the potential of the opposing electrode 20c to the first electrode 11. The absolute value (the effective value) of the second voltage V2 can be relatively large by supplying a voltage having a polarity different from the polarity of the change of the potential of the opposing electrode 20c to the second electrode 12. By such a driving method, the power supply voltage of the drive circuit can be small; and the breakdown voltage specification of the drive IC can be relaxed.

In the case where the pretilt angle of the liquid crystal layer 30 is relatively small (e.g., not more than 10 degrees), a threshold voltage Vth relating to the change of the liquid crystal alignment of the liquid crystal layer 30 is relatively distinct. In such a case, for example, the third voltage V3 is set to be not more than the threshold voltage Vth. The first voltage V1 and the second voltage V2 are set to be greater than the threshold voltage Vth.

For example, the third voltage V3 is a voltage that maintains the liquid crystal alignment of the liquid crystal layer 30 at the initial arrangement or an alignment state near the initial arrangement. The first voltage V1 and the second voltage V2 are the voltages that change the liquid crystal alignment of the liquid crystal layer 30 from the initial arrangement.

The liquid crystal alignment of the liquid crystal layer 30 is changed by the voltage applied to each of the electrodes; and the refractive index distribution is formed based on this change. The refractive index distribution is determined by the disposition of the electrodes and the voltages applied to the electrodes.

An example of the disposition of the electrodes of the liquid crystal optical apparatus 111 according to the embodiment will now be described.

In the liquid crystal optical apparatus 111 as shown in FIG. 1, the third electrode 13 is provided on the major surface 10a of the first substrate 10; the insulating layer 18 is provided on the third electrode 13; and the second electrode 12 is provided on the insulating layer 18. In other words, the second superimposed portion 13p of the third electrode 13 is disposed between the first superimposed portion 12p of the second electrode 12 and the first substrate 10. In other words, the first superimposed portion 12p of the second electrode 12 is disposed between the liquid crystal layer 30 and the second superimposed portion 13p of the third electrode 13.

In such a case, the position along the X-axis direction of each of the multiple electrode pairs 15 disposed in the first region R1 is the position along the X-axis direction of one of the two X-axis direction ends of the second electrode positioned to overlay the third electrode 13.

For example, a position 55a along the X-axis direction of the first electrode pair 15a corresponds to the position along the X-axis direction of the electrode 11-side end of the second electrode 12a included in the first electrode pair 15a. A position 55b along the X-axis direction of the second electrode pair 15b corresponds to the position along the X-axis direction of the electrode 11-side end of the second electrode 12b included in the second electrode pair 15b. A position 55c along the X-axis direction of the third electrode pair 15c corresponds to the position along the X-axis direction of the electrode 11-side end of the second electrode 12c included in the third electrode pair 15c. This is similar also in the case where four or more electrode pairs 15 are provided.

In the liquid crystal optical apparatus 111, the distance between the positions of the most proximal electrode pairs 15 disposed in the first region R1 is not constant. The distance between the positions of the most proximal electrode pairs 15 is shorter as the most proximal electrode pairs 15 are further along the +X direction (the direction from the central axis 59 toward the electrode 11p).

For example, a distance 50a (a first distance) between the position 55a of the first electrode pair 15a and the position 55b of the second electrode pair 15b is longer than a distance 50b (a second distance) between the position 55b of the second electrode pair 15b and the position 55c of the third electrode pair 15c.

In the embodiment, it is unnecessary for the distance between the positions of the adjacent first electrode pairs 15 to decrease sequentially along the +X direction for all of the adjacent first electrode pairs 15. For example, there may be portions for which the distance between the positions of the adjacent first electrode pairs 15 is the same. For example, the distance 50a between the position 55a of the first electrode pair 15a and the position 55b of the second electrode pair 15b may be the same as the distance 50b between the position 55b of the second electrode pair 15b and the position 55c of the third electrode pair 15c; and the distance 50b between the position 55b of the second electrode pair 15b and the position 55c of the third electrode pair 15c may be longer than the distance between the position 55c of the third electrode pair 15c and the position of a fourth electrode pair (not illustrated).

In other words, in the liquid crystal optical apparatus 111, the distance along the X-axis direction from the X-axis direction position of a first electrode pair of the multiple electrode pairs 15 disposed in the first region R1 to the X-axis direction position of a second electrode pair most proximal to the first electrode pair and disposed between the first electrode pair and the electrode 11p is longer than the distance along the X-axis direction from the X-axis direction position of a third electrode pair disposed between the first electrode pair and the electrode 11p in the first region R1 to the X-axis direction position of a fourth electrode pair most proximal to the third electrode pair and disposed between the third electrode pair and the electrode 11p. Here, the third electrode pair may be the same as or different from the second electrode pair.

A distance 50i between the central axis 59 and the position 55a of the first electrode pair 15a is longer than the distance 50a and longer than the distance 50b. In other words, the distances between the positions of the most proximal electrode pairs 15 disposed in the first region R1 are shorter than the distance from the position of the central axis 59 to the position of the electrode pair 15 of the multiple electrode pairs 15 that is most proximal to the central axis 59 in the first region R1.

The refraction distribution of the liquid crystal layer 30 when voltages such as those recited above are applied in the liquid crystal optical apparatus 111 including such an electrode disposition will now be described. To simplify the description hereinbelow, effects of the insulating layer 18, the alignment film, etc., on the voltages applied to the liquid crystal layer 30 (the distribution of the voltages) are ignored. To simplify the description hereinbelow, a model-like description is provided for the refractive index of the liquid crystal layer 30 with respect to light having a plane of polarization in the X-axis direction.

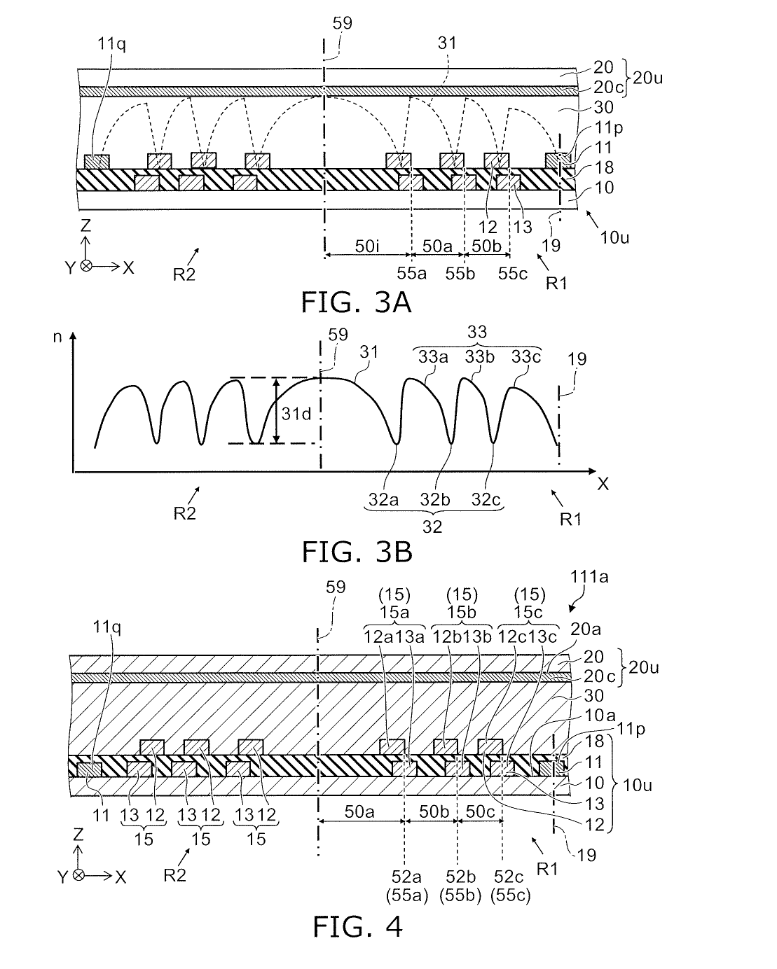

FIG. 3A and FIG. 3B are schematic views illustrating characteristics of the liquid crystal optical apparatus according to the first embodiment.

FIG. 3A is a model-like illustration of a refractive index distribution 31 of the liquid crystal optical apparatus 111.

The second voltage V2 having an absolute value (an effective value) greater than the absolute value (the effective value) of the first voltage V1 between the opposing electrode 20c and the first electrodes 11 is applied between the opposing electrode 20c and the second electrodes 12. The third voltage V3 having an absolute value (an effective value) less than the absolute value (the effective value) of the second voltage V2 is applied between the opposing electrode 20c and the third electrodes 13.

The initial alignment (in this case, the horizontal alignment) is maintained in the region of the liquid crystal layer 30 where the first voltage V1 (the low voltage) is applied. The effective refractive index of this region is a refractive index (nₑ) with respect to extraordinary light. The effective refractive index of the region of the liquid crystal layer 30 where the third voltage V3 (the low voltage) is applied also is the refractive index (nₑ) with respect to extraordinary light. An alignment having a large tilt angle (e.g., the vertical alignment) is formed in the region of the liquid crystal layer 30 where the second voltage V2 (the high voltage) is applied. The effective refractive index of this region is a refractive index (nₒ) with respect to ordinary light. The effective refractive index of the liquid crystal layer 30 opposing the region between the electrode pairs 15 is a refractive index between the refractive index with respect to extraordinary light and the refractive index with respect to ordinary light.

The change of the refractive index in the actual refractive index distribution 31 is not less than about 20% and not more than about 80% of the difference between the refractive index with respect to extraordinary light and the refractive index with respect to ordinary light.

For example, the refractive index of the portion of the liquid crystal layer 30 opposing the central portion of the second electrode 12 has a minimum. The refractive index of the liquid crystal layer 30 proximal to the portion of the liquid crystal layer 30 opposing the third electrode 13 without opposing the second electrode 12 has a maximum. For example, the refractive index has maximums proximal to the position 55a along the X-axis direction of the first electrode pair 15a, proximal to the position 55b along the X-axis direction of the second electrode pair 15b, and proximal to the position 55a along the X-axis direction of the third electrode pair 15c. The refractive index of the portion opposing the first electrode 11 has a minimum.

The change from the minimum to the maximum of the refractive index is relatively abrupt in the region of the first electrode pair 15. On the other hand, the change of the refractive index of the portion of the liquid crystal layer 30 opposing the region between the electrode pairs 15 is relatively gradual.

As shown in FIG. 3A, for example, the refractive index distribution 31 has a configuration corresponding to the distribution of the thickness of a Fresnel lens. The liquid crystal optical apparatus 111 functions as a liquid crystal GRIN lens (Gradient Index lens) in which the refractive index changes in the plane.

FIG. 3B shows an example of the actual refractive index distribution 31 of the liquid crystal optical apparatus 111. FIG. 3B is a model-like illustration of the refractive index distribution 31 of the liquid crystal optical apparatus 111 when the voltages recited above are supplied. In FIG. 3A, the horizontal axis is the X axis; and the vertical axis is a refractive index n (the effective refractive index).

As shown in FIG. 3B, the actual refractive index distribution 31 has the characteristic of a smooth curved configuration in which the characteristic illustrated in FIG. 3A has a low change rate of the refractive index due to the continuity of the liquid crystal alignment.

In the liquid crystal optical apparatus 111 as shown in FIG. 3B, the electrode pairs 15 form minimum points 32 and maximum points 33 of the refractive index. In other words, the refractive index distribution 31 of the liquid crystal layer 30 in the first region R1 includes the multiple minimum points 32 and the multiple maximum points 33 arranged alternately along the X-axis direction. The multiple minimum points 32 include a first minimum point 32a, a second minimum point 32b, a third minimum point 32c, etc. The multiple maximum points 33 include a first maximum point 33a, a second maximum point 33b, a third maximum point 33c, etc. Thus, the optical path of the light incident on the liquid crystal layer 30 is modified by the multiple minimum points 32 and the multiple maximum points 33 being formed.

The region between the adjacent first electrodes 11 (the total region of the first region R1 and the second region R2) functions as one lens. A high lens effect can be obtained with respect to the width of the change of the refractive index by the lens being formed using the multiple minimum points 32 and the multiple maximum points 33. This corresponds to, for example, a Fresnel lens having a combination of multiple curved surfaces and a lens thickness that is thinner than that of an optical lens having one curved surface while obtaining the same optical characteristics.

In the liquid crystal optical apparatus 111, the thickness of the liquid crystal layer 30 can be thin; and the amount of the liquid crystal material that is used can be reduced. Further, the response rate of the liquid crystal layer 30 increases.

In the liquid crystal optical apparatus 111, the portion of the liquid crystal layer 30 opposing the second electrode 12 is adjacent to the portion opposing the third electrode 13 when projected onto the X-Y plane because the second electrode 12 and the third electrode 13 are stacked with the insulating layer 18 interposed. Therefore, the change of the refractive index from the minimum point 32 to the maximum point 33 at one of the electrode pairs 15 can be abrupt. On the other hand, the change of the refractive index from the maximum point 33 to the minimum point 32 can be gradual between the electrode pairs 15. In other words, in the embodiment, the refractive index increase rate along the +X direction is higher than the refractive index decrease rate along the +X direction. For example, the refractive index distribution corresponds to the distribution of the lens thickness of a Fresnel lens-like configuration; and good optical characteristics can be obtained.

For example, a configuration may be considered in which the insulating layer 18 is provided on the third electrode 13, the second electrode 12 is provided on the insulating layer 18, the second electrode 12 and the third electrode 13 are not superimposed onto each other when projected onto the X-Y plane, and there is no region formed where neither the second electrode 12 nor the third electrode 13 exist when projected onto the X-Y plane. In the configuration of this reference example, the absolute value of the refractive index increase rate along the +X direction is substantially the same as the absolute value of the refractive index decrease rate along the +X direction. Therefore, for example, the diffraction effect increases; and the lens effect cannot be increased sufficiently. Therefore, a sufficient effect of guiding the incident light toward the desired direction cannot be obtained. Therefore, for example, crosstalk occurs when the liquid crystal optical apparatus 111 is combined with the image display unit 80 that displays the multiple parallax images. Therefore, the display is difficult to view; and the display quality is low.

Also, the refractive index increase rate cannot be increased sufficiently in a reference example having a configuration in which the insulating layer 18 is provided on the third electrode 13, the second electrode 12 is provided on the insulating layer 18, a region is formed where neither the second electrode 12 nor the third electrode 13 exist when projected onto the X-Y plane, and the second electrode 12 and the third electrode 13 are not superimposed onto each other when projected onto the X-Y plane. In the region where the refractive index increases along the +X direction, light is guided toward unintended directions particularly for oblique light. In other words, stray light occurs. Therefore, for example, crosstalk occurs; and the display quality is low.

Conversely, in the liquid crystal optical apparatus 111 according to the embodiment, the change of the refractive index from the minimum point 32 to the maximum point 33 at one of the electrode pairs 15 can be abrupt because the second electrode 12 and the third electrode 13 are stacked with the insulating layer 18 interposed. Therefore, stray light can be suppressed. Also, the change of the refractive index from the maximum point 33 to the minimum point 32 can be gradual because the electrode pairs 15 are separated from each other; and a good lens effect is obtained.

According to the liquid crystal optical apparatus 111 according to the embodiment, a liquid crystal optical apparatus that provides a high-quality display can be provided.

Further, in the embodiment, the distance between the positions of the most proximal electrode pairs 15 is shorter as the most proximal electrode pairs 15 are further along the +X direction. Thereby, the effect of reducing the operating voltage also is obtained.

The stray light has a greater effect on the degradation of the image in the region of the first region R1 proximal to the central axis 59 than in the region of the first region R1 distal to the central axis 59. Therefore, it is favorable for the refractive index increase rate of the region of the first region R1 proximal to the central axis 59 to be higher than the refractive index increase rate of the region of the first region R1 distal to the central axis 59. Thereby, substantial degradation of the image can be suppressed further.

For example, a high refractive index increase rate can be obtained at each of the electrode pairs 15 by using high voltages. However, reverse tilt occurs easily in the case where the high voltages are applied to the liquid crystal layer 30. The reverse tilt causes disorder of the refractive index distribution to occur and is a cause of stray light.

In the embodiment, the refractive index increase rate is increased while suppressing the increase of the voltages to change the liquid crystal alignment by reducing the disposition pitch of the electrode pairs 15 in the region proximal to the central axis 59. Thereby, the refractive index increase rate proximal to the central axis 59 is increased even in the case where low operating voltages are used; and a high-quality display can be maintained.

This effect is obtained for the configuration in which the second electrode 12 and the third electrode 13 are stacked with the insulating layer 18 interposed and the electrode pairs 15 are separated from each other.

As shown in FIG. 3B, the refractive index increase rate is the absolute value of the slope of a straight line connecting one minimum point of the multiple minimum points 32 (e.g., the first minimum point 32a) to a maximum point (the first maximum point 33a) adjacent to the one minimum point (the first minimum point 32a) in the region between the one minimum point (the first minimum point 32a) and the position 19 of the electrode 11p.

The refractive index increase rate of the first minimum point of the multiple minimum points 32 is higher than the refractive index increase rate of a second minimum point of the multiple minimum points 32 that is more distal to the central axis 59 than is the first minimum point. The first minimum point of the multiple minimum points 32 may be any of the first minimum point 32a, the second minimum point 32b, and the third minimum point 32c shown in FIG. 3B and the like.

Thus, in the liquid crystal optical apparatus 111, the stray light can be effectively suppressed by the refractive index increase rate of the minimum point 32 proximal to the central axis 59 being higher than the refractive index increase rate of the minimum point 32 distal to the central axis 59; and a higher-quality display can be provided.

In the liquid crystal optical apparatus 111, the absolute value of the first voltage V1 may be greater than the absolute value of the second voltage V2 and the greater than the absolute value of the third voltage V3. In such a case, the absolute value of the second voltage V2 may be greater than the absolute value of the third voltage V3. Or, the absolute value of the third voltage V3 may be greater than the absolute value of the second voltage V2.

FIG. 4 is a schematic cross-sectional view illustrating the configuration of another liquid crystal optical apparatus according to the first embodiment.

In the liquid crystal optical apparatus 111a as shown in FIG. 4, the configuration of the first substrate unit 10u differs from that of the liquid crystal optical apparatus 111. The configurations of the second substrate unit 20u and the liquid crystal layer 30 of the liquid crystal optical apparatus 111a are similar to those of the liquid crystal optical apparatus 111, and a description is therefore omitted.

In the liquid crystal optical apparatus 111a, the first electrodes 11 are provided on the first major surface 10a of the first substrate 10; and the insulating layer 18 covers the first electrodes 11. The configuration of the electrode pair 15 is similar to that of the liquid crystal optical apparatus 111, and a description is therefore omitted.

In the liquid crystal optical apparatus 111a as well, the refractive index distribution 31 described in regard to FIG. 3B and FIG. 3B can be formed by applying the first voltage V1 between the opposing electrode 20c and the first electrodes 11 and by applying the second voltage V2 between the opposing electrode 20c and the second electrodes 12, where the first voltage V1 has an absolute value (an effective value) greater than the absolute value (the effective value) of the third voltage V3 between the opposing electrode 20c and the third electrodes 13, and the second voltage V2 has an absolute value (an effective value) greater than the absolute value (the effective value) of the third voltage V3. Thereby, a high-quality display can be provided.

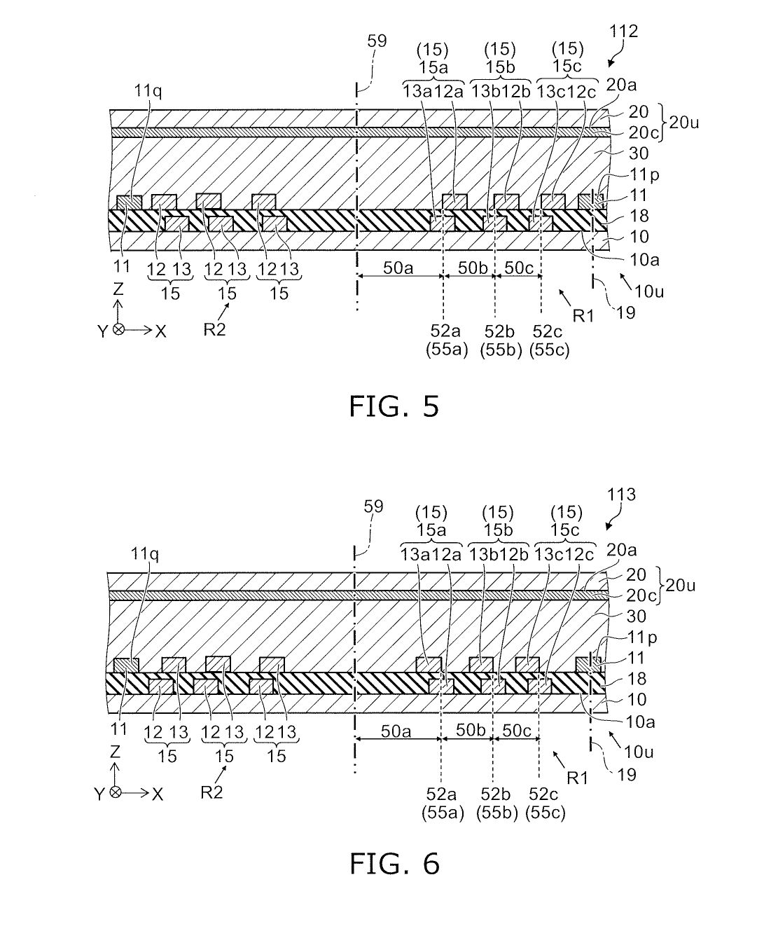

FIG. 5 is a schematic cross-sectional view illustrating the configuration of another liquid crystal optical apparatus according to the first embodiment.

In the liquid crystal optical apparatus 112 as shown in FIG. 5, the configuration of the first substrate unit 10u differs from that of the liquid crystal optical apparatus 111. In the liquid crystal optical apparatus 112, the configurations of the second substrate unit 20u and the liquid crystal layer 30 are similar to those of the liquid crystal optical apparatus 111, and a description is therefore omitted.

In the liquid crystal optical apparatus 112, the third electrode 13 is provided on the first substrate 10; the insulating layer 18 is provided on the third electrode 13; and the second electrode 12 is provided on the insulating layer 18. In this example, the first electrode 11 is provided on the insulating layer 18. The first electrode 11 may be disposed between the insulating layer 18 and the first substrate 10.

In this example, the first superimposed portion 12p of the second electrode 12 is disposed between the second superimposed portion 13p of the third electrode 13 and the liquid crystal layer 30. In such a case, the position along the X-axis direction of each of the multiple electrode pairs 15 disposed in the first region R1 corresponds to the position along the X-axis direction of one of the two X-axis direction ends of the second electrode 12 positioned to overlay the third electrode 13.

For each of the multiple electrode pairs 15 included in the first region R1, the distance between the second non-superimposed portion 13q and the central axis 59 is shorter than the distance between the first non-superimposed portion 12q and the central axis 59. In other words, in one of the electrode pairs 15 of the first region R1, the third electrode 13 is more proximal to the central axis 59 than is the second electrode 12.

In such a case, the drive unit 72 (not illustrated in FIG. 5) applies a fifth voltage V5 between the opposing electrode 20c and the first electrodes 11, where the fifth voltage V5 has an absolute value (an effective value) greater than the absolute value (the effective value) of a fourth voltage V4 between the opposing electrode 20c and the second electrodes 12. The drive unit 72 applies a sixth voltage V6 between the opposing electrode 20c and the third electrodes 13, where the sixth voltage V6 has an absolute value (an effective value) greater than the absolute value (the effective value) of the fourth voltage V4.

Thereby, for example, the refractive index of the portion of the liquid crystal layer 30 opposing the central portion of the third electrode 13 has a minimum. The refractive index of the liquid crystal layer 30 proximal to the portion of the liquid crystal layer 30 opposing the second electrode 12 without opposing the third electrode 13 has a maximum. For example, the refractive index has maximums proximal to the position 55a along the X-axis direction of the first electrode pair 15a, proximal to the position 55b along the X-axis direction of the second electrode pair 15b, and proximal to the position 55a along the X-axis direction of the third electrode pair 15c. The refractive index of the portion opposing the first electrode 11 has a minimum.

That is, in the liquid crystal optical apparatus 112, the drive unit 72 applies a first voltage V1 between the opposing electrode 20c and the first electrodes 11, applies a second voltage V2 between the opposing electrode 20c and the second electrodes 12, and applies a third voltage V3 between the opposing electrode 20c and the third electrodes 13. The absolute value of the first voltage V1 is greater than the absolute value of the second voltage V2 and the greater than the absolute value of the third voltage V3. The absolute value of the second voltage V2 may be greater than the absolute value of the third voltage V3. Or, the absolute value of the third voltage V3 may be greater than the absolute value of the second voltage V2.

FIG. 6 is a schematic cross-sectional view illustrating the configuration of another liquid crystal optical apparatus according to the first embodiment.

In the liquid crystal optical apparatus 113 as shown in FIG. 6, the configuration of the first substrate unit 10u differs from that of the liquid crystal optical apparatus 111. In the liquid crystal optical apparatus 113, the configurations of the second substrate unit 20u and the liquid crystal layer 30 are similar to those of the liquid crystal optical apparatus 111, and a description is therefore omitted.

In the liquid crystal optical apparatus 113, the second electrode 12 is provided on the first substrate 10; the insulating layer 18 is provided on the second electrode 12; and the third electrode 13 is provided on the insulating layer 18. In this example, the first electrode 11 is provided on the insulating layer 18. The first electrode 11 may be disposed between the insulating layer 18 and the first substrate 10.

In this example, the second superimposed portion 13p of the third electrode 13 is disposed between the first superimposed portion 12p of the second electrode 12 and the liquid crystal layer 30. In such a case, the position along the X-axis direction of each of the multiple electrode pairs 15 disposed in the first region R1 corresponds to the position along the X-axis direction of one of the two X-axis direction ends of the third electrode 13 positioned to overlay the second electrode 12.

For each of the multiple electrode pairs 15 included in the first region R1, the distance between the second non-superimposed portion 13q and the central axis 59 is shorter than the distance between the first non-superimposed portion 12q and the central axis 59. In other words, in one of the electrode pairs 15 of the first region R1, the third electrode 13 is more proximal to the central axis 59 than is the second electrode 12.

In such a case, the drive unit 72 (not illustrated in FIG. 6) applies an eighth voltage V8 between the opposing electrode 20c and the first electrodes 11, where the eighth voltage V8 has an absolute value (an effective value) greater than the absolute value (the effective value) of a seventh voltage V7 between the opposing electrode 20c and the second electrodes 12. The drive unit 72 applies a ninth voltage V9 between the opposing electrode 20c and the third electrodes 13, where the ninth voltage V9 has an absolute value (an effective value) greater than the absolute value (the effective value) of the seventh voltage V7.

Thereby, for example, the refractive index of the portion of the liquid crystal layer 30 opposing the central portion of the third electrode 13 has a minimum. The refractive index of the liquid crystal layer 30 proximal to the portion of the liquid crystal layer 30 opposing the second electrode 12 without opposing the third electrode 13 has a maximum. For example, the refractive index has maximums proximal to the position 55a along the X-axis direction of the first electrode pair 15a, proximal to the position 55b along the X-axis direction of the second electrode pair 15b, and proximal to the position 55a along the X-axis direction of the third electrode pair 15c. The refractive index of the portion opposing the first electrode 11 has a minimum.

In the liquid crystal optical apparatus 113, the drive unit 72 applies a first voltage V1 between the opposing electrode 20c and the first electrodes 11, applies a second voltage V2 between the opposing electrode 20c and the second electrodes 12, and applies a third voltage V3 between the opposing electrode 20c and the third electrodes 13. The absolute value of the first voltage V1 may be greater than the absolute value of the second voltage V2 and the greater than the absolute value of the third voltage V3. The absolute value of the second voltage V2 may be greater than the absolute value of the third voltage V3. Or, the absolute value of the third voltage V3 may be greater than the absolute value of the second voltage V2.

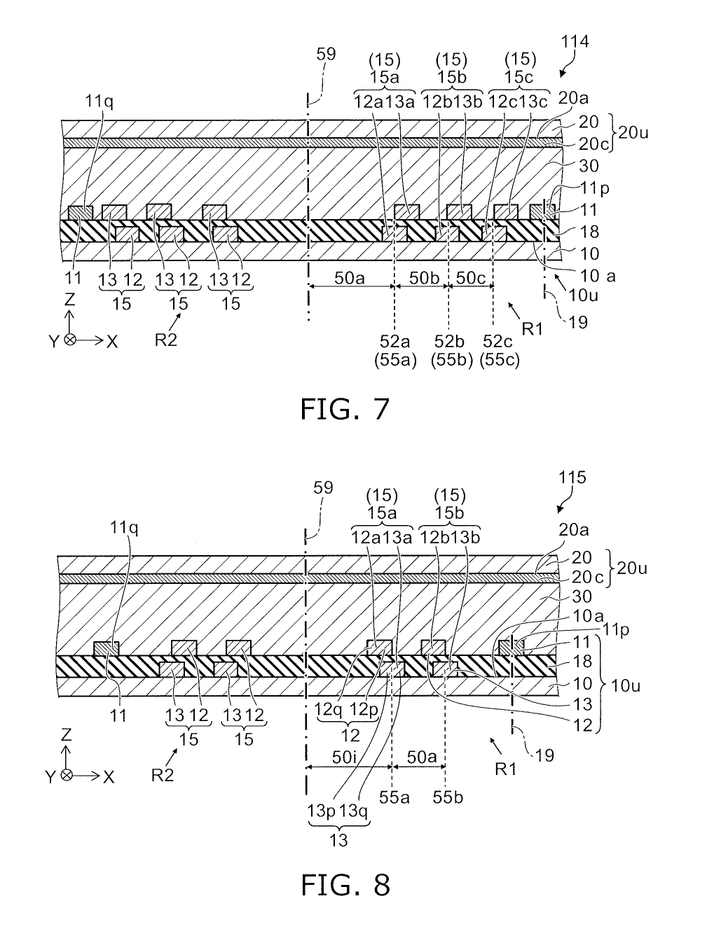

FIG. 7 is a schematic cross-sectional view illustrating the configuration of another liquid crystal optical apparatus according to the first embodiment.

In the liquid crystal optical apparatus 114 as shown in FIG. 7, the configuration of the first substrate unit 10u differs from that of the liquid crystal optical apparatus 111. In the liquid crystal optical apparatus 114, the configurations of the second substrate unit 20u and the liquid crystal layer 30 are similar to those of the liquid crystal optical apparatus 111, and a description is therefore omitted.

In the liquid crystal optical apparatus 114, the second electrode 12 is provided on the first substrate 10; the insulating layer 18 is provided on the second electrode 12; and the third electrode 13 is provided on the insulating layer 18. In this example, the first electrode 11 is provided on the insulating layer 18. The first electrode 11 may be disposed between the insulating layer 18 and the first substrate 10.

In this example as well, the second superimposed portion 13p of the third electrode 13 is disposed between the first superimposed portion 12p of the second electrode 12 and the liquid crystal layer 30. In such a case, the position along the X-axis direction of each of the multiple electrode pairs 15 disposed in the first region R1 corresponds to the position along the X-axis direction of one of the two X-axis direction ends of the third electrode 13 positioned to overlay the second electrode 12.

For each of the multiple electrode pairs 15 included in the first region R1, the distance between the second non-superimposed portion 13q and the central axis 59 is longer than the distance between the first non-superimposed portion 12q and the central axis 59. In other words, in one of the electrode pairs 15 of the first region R1, the third electrode 13 is more distal to the central axis 59 than is the second electrode 12.

In such a case, the drive unit 72 (not illustrated in FIG. 7) applies an eleventh voltage V11 between the opposing electrode 20c and the first electrodes 11, where the eleventh voltage V11 has an absolute value (an effective value) greater than the absolute value (the effective value) of a tenth voltage V10 between the opposing electrode 20c and the third electrodes 13. The drive unit 72 applies a twelfth voltage V12 between the opposing electrode 20c and the second electrodes 12, where the twelfth voltage V12 has an absolute value greater than the absolute value (the effective value) of the tenth voltage V10.

Thereby, for example, the refractive index of the portion of the liquid crystal layer 30 opposing the X-axis direction central portion of the second electrode 12 has a minimum. The refractive index of the liquid crystal layer 30 proximal to the portion of the liquid crystal layer 30 opposing the third electrode 13 without opposing the second electrode 12 has a maximum. For example, the refractive index has maximums proximal to the position 55a along the X-axis direction of the first electrode pair 15a, proximal to the position 55b along the X-axis direction of the second electrode pair 15b, and proximal to the position 55a along the X-axis direction of the third electrode pair 15c. The refractive index of the portion opposing the first electrode 11 has a minimum.

That is, in the liquid crystal optical apparatus 114, the drive unit 72 applies a first voltage V1 between the opposing electrode 20c and the first electrodes 11, applies a second voltage V2 between the opposing electrode 20c and the second electrodes 12, and applies a third voltage V3 between the opposing electrode 20c and the third electrodes 13. The absolute value of the first voltage V1 is greater than the absolute value of the second voltage V2 and the greater than the absolute value of the third voltage V3. The absolute value of the second voltage V2 may be greater than the absolute value of the third voltage V3. Or, the absolute value of the third voltage V3 may be greater than the absolute value of the second voltage V2.

In the liquid crystal optical apparatuses 112, 113, and 114 as well, the change from the minimum point to the maximum point of the refractive index at one electrode pair 15 can be abrupt; and the stray light can be suppressed. Also, the change of the refractive index from the maximum point to the minimum point can be gradual because the electrode pairs 15 are separated from each other; and a good lens effect is obtained. Thereby, a high-quality display can be provided.

For example, in the case where the threshold voltage Vth exists, the fourth voltage V4, the seventh voltage V7, and the tenth voltage V10 are set to be not more than the threshold voltage Vth. The fifth voltage V5, the sixth voltage V6, the eighth voltage V8, the ninth voltage V9, the eleventh voltage V11, and the twelfth voltage V12 are set to be greater than the threshold voltage Vth.

Similarly to the description regarding the first voltage V1 to the third voltage V3, the voltage of a direct current or an alternating current can be used as the fourth voltage V4 to the twelfth voltage V12. Voltage waveforms in which the timing of the polarity reversal is temporally shifted may be appropriately applied to these voltages.

In the liquid crystal optical apparatuses 111 to 114 and 111a according to the embodiment, the refractive index increase rate of the first minimum point of the multiple minimum points 32 can be higher than the refractive index increase rate of the second minimum point of the multiple minimum points 32 that is more distal to the central axis 59 than is the first minimum point by adjusting the first to twelfth voltages V1 to V12.

FIG. 8 is a schematic cross-sectional view illustrating the configuration of another liquid crystal optical apparatus according to the first embodiment.

As shown in FIG. 8, the liquid crystal optical apparatus 115 according to the embodiment also includes the first substrate unit 10u, the second substrate unit 20u, and the liquid crystal layer 30. The first substrate unit 10u includes the first substrate 10, the multiple first electrodes 11, and the multiple electrode pairs 15.

In this example, two electrode pairs 15 (the first electrode pair 15a and the second electrode pair 15b) are provided in the first region R1. Two electrode pairs 15 also are provided in the second region R2. Otherwise, the configuration (e.g., the second substrate unit 20u, the liquid crystal layer 30, etc.) is similar to that of the liquid crystal optical apparatus 111a, and a description is therefore omitted.

The distance 50i between the central axis 59 and the position 55a of the first electrode pair 15a is longer than the distance 50a and longer than the distance 50b. In other words, the distance between the positions of the most proximal electrode pairs 15 disposed in the first region R1 is shorter than the distance from the position of the central axis 59 to the position of the electrode pair 15 of the multiple electrode pairs 15 that is most proximal to the central axis 59 in the first region R1.

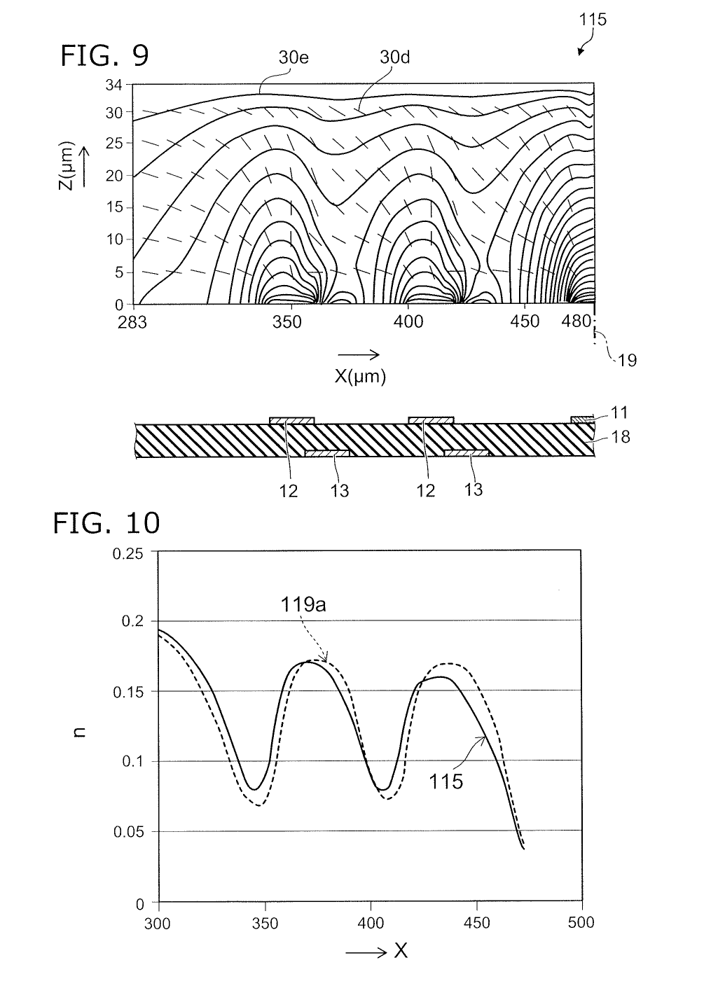

FIG. 9 is a schematic view illustrating characteristics of another liquid crystal optical apparatus according to the first embodiment.

FIG. 9 schematically illustrates the simulation result of an equipotential distribution 30e and a liquid crystal director 30d of the liquid crystal layer 30 of the liquid crystal optical apparatus 115. In FIG. 9, the horizontal axis is the X-axis direction position; and the vertical axis is the Z-axis direction position. The length (the width) of the second electrode 12 along the X-axis direction and the length (the width) of the third electrode 13 along the X-axis direction are 20 μm; and the lengths (the widths) of the overlaying portions of the second electrode 12 and the third electrode 13 (the first superimposed portion 12p and the second superimposed portion 13p) along the X-axis direction are 5 μm. The spacing between the second electrodes 12 and the spacing between the third electrodes 13 are 40 μm. The thickness of the liquid crystal layer 30 is 34 μm. In this example, the absolute value of the first voltage V1 and the absolute value of the second voltage V2 are 2.8 V. The absolute value of the third voltage V3 is 0 V.

As shown in FIG. 9, the equipotential curve of the portion corresponding to the second non-superimposed portion 13q is asymmetrical along the X-axis direction. In other words, the equipotential curve of the second non-superimposed portion 13q on the side proximal to the second superimposed portion 13p is different from the equipotential curve of the second non-superimposed portion 13q on the side distal to the second superimposed portion 13p.

FIG. 10 is a graph illustrating characteristics of liquid crystal optical apparatuses.

FIG. 10 illustrates the optical characteristics of the liquid crystal optical apparatus 115 according to the embodiment. In FIG. 10, the horizontal axis is the position along the X-axis direction. The vertical axis is the refractive index n (the effective refractive index). The refractive index is ascertained from the distribution of the liquid crystal director 30d recited above.

FIG. 10 also illustrates the optical characteristics of a liquid crystal optical apparatus 119a of a reference example (the structure of the liquid crystal optical apparatus 119a is not illustrated). In the liquid crystal optical apparatus 119a, the second electrode 12 does not have a portion overlaying the third electrode 13. The length of the second electrode 12 along the X-axis direction and the length of the third electrode 13 along the X-axis direction are 30 μm. The spacing between the second electrodes 12 and the spacing between the third electrodes 13 are 30 μm. In the liquid crystal optical apparatus 119a, one selected from the second electrode 12 and the third electrode 13 is provided and there is no region where an electrode is not provided between the first electrodes 11 when viewed along the Z-axis direction. Otherwise, the liquid crystal optical apparatus 119a is similar to the liquid crystal optical apparatus 115.

In the liquid crystal optical apparatus 119a of the reference example as shown in FIG. 10, the curve of the increase of the refractive index along the +X direction is substantially the same as the curve of the decrease of the refractive index along the +X direction. The length of the increasing interval of the refractive index along the X-axis direction is substantially the same as the length of the decreasing interval of the refractive index along the X-axis direction. Therefore, the stray light occurs easily.

Conversely, in the liquid crystal optical apparatus 115 according to the embodiment, the length of the increasing interval of the refractive index along the X-axis direction is shorter than the length of the decreasing interval of the refractive index along the X-axis direction. Therefore, the stray light can be suppressed; and a good lens effect is obtained.

### Second Embodiment

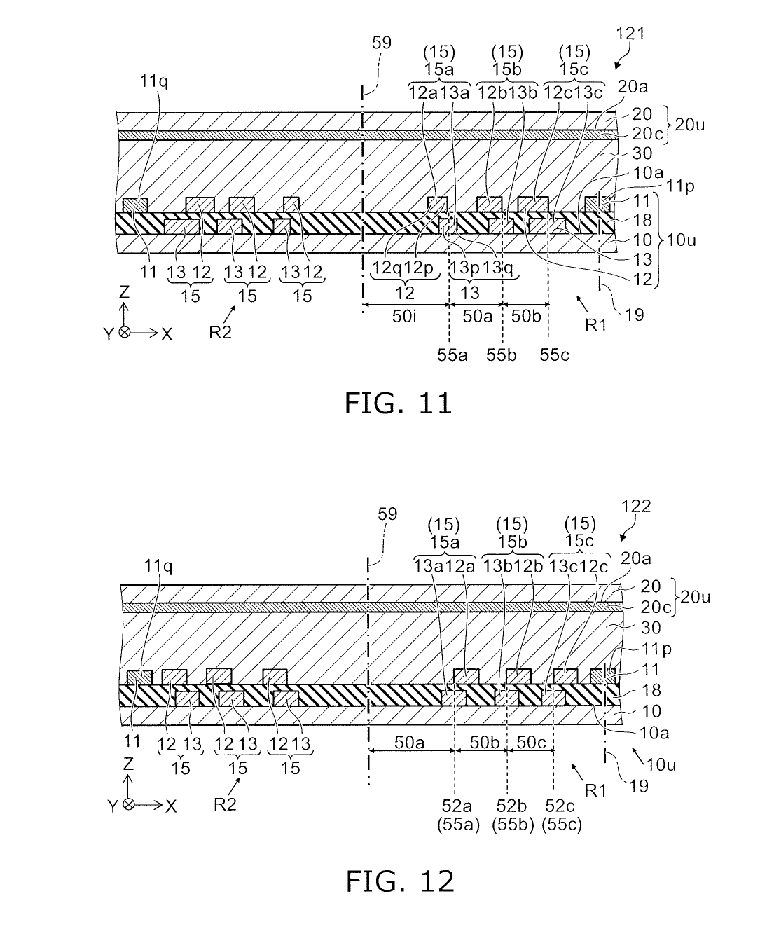

FIG. 11 is a schematic cross-sectional view illustrating the configuration of a liquid crystal optical apparatus according to a second embodiment. As shown in FIG. 11, the liquid crystal optical apparatus 121 according to the embodiment also includes the first substrate unit 10u, the second substrate unit 20u, and the liquid crystal layer 30. In the liquid crystal optical apparatus 121, the configurations of the second substrate unit 20u and the liquid crystal layer 30 are similar to those of the first embodiment (e.g., the liquid crystal optical apparatus 111), and a description is therefore omitted.

In the liquid crystal optical apparatus 121 as well, the first substrate unit 10u includes the first substrate 10, the multiple first electrodes 11, and the multiple electrode pairs 15. Each of the multiple electrode pairs 15 includes the second electrode 12 and the third electrode 13. In the liquid crystal optical apparatus 121, the width of the second electrode 12 is different between the multiple electrode pairs 15. Also, the width of the third electrode 13 is different between the multiple electrode pairs 15. Otherwise, the configuration is similar to that of the liquid crystal optical apparatus 111, and a description is therefore omitted. The width of the second electrode 12 and the width of the third electrode 13 will now be described.

In the liquid crystal optical apparatus 121, the width (the length along the second direction) of the second electrode 12 included in each of the multiple electrode pairs 15 disposed in the first region R1 is greater as the second electrode 12 is further along the direction (the +X direction) from the central axis 59 toward the electrode 11p.

The length (the width) along the X-axis direction of the first non-superimposed portion 12q included in each of the multiple electrode pairs 15 disposed in the first region R1 is greater as the first non-superimposed portion 12q is further along the +X-axis direction.

In the liquid crystal optical apparatus 121, similarly to the liquid crystal optical apparatus 111, the first voltage V1 is applied between the opposing electrode 20c and the first electrodes 11; the second voltage V2 is applied between the opposing electrode 20c and the second electrodes 12; and the third voltage V3 is applied between the opposing electrode 20c and the third electrodes 13. The absolute value (the effective value) of the first voltage V1 is greater than the absolute value (the effective value) of the third voltage V3; and the absolute value (the effective value) of the second voltage V2 is less than the absolute value (the effective value) of the third voltage V3.

In the liquid crystal optical apparatus 121, a good refractive index distribution can be formed also at positions distal to the central axis 59 by the width of the first non-superimposed portion 12q being wider further along the +X-axis direction.

In the region proximal to the central axis 59 as described in regard to FIG. 3B, the difference (a refractive index difference 31d) between the maximum point 33 and the minimum point 32 of the refractive index distribution 31 is relatively large. Conversely, in the region distal to the central axis 59 (e.g., proximal to the position 19 of the electrode 11p), the refractive index difference 31d is relatively small.

It is considered that this is caused by the electric field density proximal to the electrode 11p (the end portion of the lens) being more concentrated than the electric field density proximal to the central axis 59 (the center of the lens). In other words, there is a tendency for the refractive index difference 31d proximal to the electrode 11p to be less than the refractive index difference 31d proximal to the central axis 59 even in the case where the same voltage is applied.

Therefore, in the embodiment, the width of the first non-superimposed portion 12q that applies the second voltage V2 (the high voltage) proximal to the electrode 11p is wider than the width of the first non-superimposed portion 12q proximal to the central axis 59. Thereby, proximal to the electrode 11p as well, the director of the liquid crystal molecules can be oriented sufficiently in the Z-axis direction based on the second voltage V2. Thereby, at the end portion of the lens (proximal to the electrode 11p) as well, a sufficiently large refractive index difference 31d can be formed.

Although the width of the second electrode 12 is different between the multiple electrode pairs 15 and the width of the third electrode 13 is different between the multiple electrode pairs 15 in the liquid crystal optical apparatus 121, the width of the third electrode 13 may be constant, and the width of the second electrode 12 may be different between the multiple electrode pairs 15.

FIG. 12 is a schematic cross-sectional view illustrating the configuration of another liquid crystal optical apparatus according to the second embodiment.

As shown in FIG. 12, the liquid crystal optical apparatus 122 according to the embodiment is the liquid crystal optical apparatus 112 described in regard to the first embodiment in which the width of the second electrode 12 is different between the multiple electrode pairs 15; and the width of the third electrode 13 is different between the multiple electrode pairs 15. Otherwise, the configuration is similar to that of the liquid crystal optical apparatus 112, and a description is therefore omitted. Portions different from those of the liquid crystal optical apparatus 112 will now be described.

In the liquid crystal optical apparatus 122, the width (the length along the second direction) of the third electrode 13 included in each of the multiple electrode pairs 15 disposed in the first region R1 is greater as the third electrode 13 is further along the direction (the +X direction) from the central axis 59 toward the electrode 11p.

The length (the width) along the X-axis direction of the second non-superimposed portion 13q included in each of the multiple electrode pairs 15 disposed in the first region R1 is greater as the second non-superimposed portion 13q is further along the +X direction.

In the liquid crystal optical apparatus 122, similarly to the liquid crystal optical apparatus 112, the fifth voltage V5 is applied between the opposing electrode 20c and the first electrodes 11, where the fifth voltage V5 has an absolute value (an effective value) greater than the absolute value (the effective value) of the fourth voltage V4 between the opposing electrode 20c and the second electrodes 12. The sixth voltage V6 is applied between the opposing electrode 20c and the third electrodes 13, where the sixth voltage V6 has an absolute value (an effective value) greater than the absolute value (the effective value) of the fifth voltage V5.

In the liquid crystal optical apparatus 112, the width of the second non-superimposed portion 13q of the third electrode 13 that applies the high voltage is wider for the third electrode 13 proximal to the central axis 59 than for the third electrode 13 proximal to the electrode 11p. Thereby, proximal to the electrode 11p as well, the director of the liquid crystal molecules can be sufficiently oriented in the Z-axis direction based on the high voltage. Thereby, at the end portion of the lens (proximal to the electrode 11p) as well, a sufficiently large refractive index difference 31d can be formed.

Although the width of the second electrode 12 is different between the multiple electrode pairs 15 and the width of the third electrode 13 is different between the multiple electrode pairs 15 in the liquid crystal optical apparatus 122, the width of the second electrode 12 may be constant, and the width of the third electrode 13 may be different between the multiple electrode pairs 15.

Further, in the liquid crystal optical apparatuses 113 and 114 described in regard to the first embodiment, the width of the third electrode 13 may be modified to be different between the multiple electrode pairs 15 even in the case where the width of the second electrode 12 is modified to be different between the multiple electrode pairs 15.

In the first and second embodiments, another electrode may be provided in the first substrate unit 10u at a position overlaying the central axis 59. The potential difference between this electrode and the opposing electrode 20c is set to have a low value (e.g., not more than the threshold voltage Vth).

According to the embodiments, a liquid crystal optical apparatus and an image display device that provide a high-quality display can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the invention is not limited to these specific examples. For example, one skilled in the art may similarly practice the invention by appropriately selecting specific configurations of components included in liquid crystal optical apparatuses such as first substrate units, second substrate units, liquid crystal layers, first substrates, second substrates, first to fourth electrodes, insulating layers, and drive units and specific configurations of components included in image display devices such as display units, display drive units, etc., from known art; and such practice is included in the scope of the invention to the extent that similar effects are obtained.

Further, any two or more components of the specific examples may be combined within the extent of technical feasibility and are included in the scope of the invention to the extent that the purport of the invention is included.

Moreover, all liquid crystal optical apparatuses and image display devices practicable by an appropriate design modification by one skilled in the art based on the liquid crystal optical apparatuses and the image display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A liquid crystal optical apparatus, comprising:
a first substrate unit including
a first substrate having a first major surface,
a plurality of first electrodes provided on the first major surface, the first electrodes extending in a first direction and being arranged in a second direction orthogonal to the first direction, and
a plurality of electrode pairs provided between the first electrodes on the first major surface, the electrode pairs being arranged in the second direction, each electrode pair including
a second electrode extending in the first direction,
a third electrode extending in the first direction, and
an insulating layer provided between the second electrode and the third electrode,
the second electrode and the third electrode being overlapped partly each other when projected onto a plane parallel to the first substrate;
a second substrate unit including
a second substrate having a second major surface opposing the first major surface, and
an opposing electrode provided on the second major surface; and
a liquid crystal layer provided between the first substrate unit and the second substrate unit,
a first distance along the second direction from a position of a first pair of the electrode pairs to a position of a second pair most proximal to the first pair and disposed between the first pair and one electrode of two most proximal first electrodes being shorter than a distance along the second direction from a central axis between the first electrodes to the position of the first pair, the central axis being parallel to the first direction to pass through a midpoint of a line segment connecting centers of the two most proximal first electrodes in the second direction.

2. The apparatus according to claim 1, wherein the first distance is longer than a second distance along the second direction from the position of the second pair to a third pair of the electrode pairs disposed between the one electrode and the second pair.

3. The apparatus according to claim 1, wherein the electrode pairs are separated from each other when projected onto the plane.

4. The apparatus according to claim 1, wherein lengths along the second direction of an area on the second electrode not being overlapped with the third electrode are longer as the second electrode are further along a direction from the central axis toward the one electrode.

5. The apparatus according to claim 1, wherein lengths along the second direction of an area on the third electrode not being overlapped with the second electrode are longer as the third electrodes are further along a direction from the central axis toward the one electrode.

6. The apparatus according to claim 1, wherein lengths along the second direction of an area on the second electrode overlapped with the third electrode are longer as the second electrodes are further along a direction from the central axis toward the one electrode.

7. The apparatus according to claim 1, wherein
the second electrode has a first superimposed portion overlaying the third electrode and a first non-superimposed portion not overlaying the third electrode when projected onto the plane,
the third electrode has a second superimposed portion overlaying the second electrode and a second non-superimposed portion not overlaying the second electrode when projected onto the plane,
the first superimposed portion is disposed between the second superimposed portion and the liquid crystal layer, and
a distance between the second non-superimposed portion and the central axis is longer than a distance between the first non-superimposed portion and the central axis.

8. The apparatus according to claim 1, wherein
the second electrode has a first superimposed portion overlaying the third electrode and a first non-superimposed portion not overlaying the third electrode when projected onto the plane,
the third electrode has a second superimposed portion overlaying the second electrode and a second non-superimposed portion not overlaying the second electrode when projected onto the plane,
the first superimposed portion is disposed between the second superimposed portion and the liquid crystal layer, and
a distance between the second non-superimposed portion and the central axis is shorter than a distance between the first non-superimposed portion and the central axis.

9. The apparatus according to claim 1, wherein
the second electrode has a first superimposed portion overlaying the third electrode and a first non-superimposed portion not overlaying the third electrode when projected onto the plane,
the third electrode has a second superimposed portion overlaying the second electrode and a second non-superimposed portion not overlaying the second electrode when projected onto the plane,
the second superimposed portion is disposed between the first superimposed portion and the liquid crystal layer, and
a distance between the second non-superimposed portion and the central axis is shorter than a distance between the first non-superimposed portion and the central axis.

10. The apparatus according to claim 1, wherein
the second electrode has a first superimposed portion overlaying the third electrode and a first non-superimposed portion not overlaying the third electrode when projected onto the plane,
the third electrode has a second superimposed portion overlaying the second electrode and a second non-superimposed portion not overlaying the second electrode when projected onto the plane,
the second superimposed portion is disposed between the first superimposed portion and the liquid crystal layer, and
a distance between the second non-superimposed portion and the central axis is longer than a distance between the first non-superimposed portion and the central axis.

11. The apparatus according to claim 1, further comprising a drive unit electrically connected to the opposing electrode and the first to third electrodes,
the drive unit being configured to apply a first voltage between the opposing electrode and the first electrodes, a second voltage between the opposing electrode and the second electrodes, a third voltage between the opposing electrode and the third electrodes, an absolute value of the first voltage being greater than an absolute value of the second voltage and greater than an absolute value of the third voltage.

12. The apparatus according to claim 11, wherein
the first pair is disposed in a first region, the first region is between the central axis and one electrode,
a distribution of a refractive index of the liquid crystal layer of the first region has a plurality of minimum points and a plurality of maximum points arranged alternately along the second direction when the drive unit applies the first, second and third voltages, and
a refractive index increase rate of a first minimum point of the minimum points is higher than a refractive index increase rate of a second minimum point of the minimum points more distal to the central axis than is the first minimum point, where the refractive index increase rate is an absolute value of a slope of a straight line connecting one minimum point of the minimum points to the maximum point adjacent to the one minimum point between the one minimum point and the position of the one electrode.

13. The apparatus according to claim 11, wherein the absolute value of the second voltage is greater than the absolute value of the third voltage.

14. The apparatus according to claim 11, wherein the absolute value of the third voltage is greater than the absolute value of the second voltage.

15. The apparatus according to claim 11, wherein
the second electrode has a first superimposed portion overlaying the third electrode and a first non-superimposed portion not overlaying the third electrode when projected onto the plane,
the third electrode has a second superimposed portion overlaying the second electrode and a second non-superimposed portion not overlaying the second electrode when projected onto the plane,
the first superimposed portion is disposed between the second superimposed portion and the liquid crystal layer, and
a distance between the second non-superimposed portion and the central axis is longer than a distance between the first non-superimposed portion and the central axis.

16. The apparatus according to claim 11, wherein
the second electrode has a first superimposed portion overlaying the third electrode and a first non-superimposed portion not overlaying the third electrode when projected onto the plane,
the third electrode has a second superimposed portion overlaying the second electrode and a second non-superimposed portion not overlaying the second electrode when projected onto the plane,
the first superimposed portion is disposed between the second superimposed portion and the liquid crystal layer, and
a distance between the second non-superimposed portion and the central axis is shorter than a distance between the first non-superimposed portion and the central axis.

17. The apparatus according to claim 11, wherein
the second electrode has a first superimposed portion overlaying the third electrode and a first non-superimposed portion not overlaying the third electrode when projected onto the plane,
the third electrode has a second superimposed portion overlaying the second electrode and a second non-superimposed portion not overlaying the second electrode when projected onto the plane,
the second superimposed portion is disposed between the first superimposed portion and the liquid crystal layer, and
a distance between the second non-superimposed portion and the central axis is shorter than a distance between the first non-superimposed portion and the central axis.

18. The apparatus according to claim 11, wherein
the second electrode has a first superimposed portion overlaying the third electrode and a first non-superimposed portion not overlaying the third electrode when projected onto the plane,
the third electrode has a second superimposed portion overlaying the second electrode and a second non-superimposed portion not overlaying the second electrode when projected onto the plane,
the second superimposed portion is disposed between the first superimposed portion and the liquid crystal layer, and
a distance between the second non-superimposed portion and the central axis is longer than a distance between the first non-superimposed portion and the central axis.

19. An image display device, comprising:
a liquid crystal optical apparatus; and
an image display unit including a display unit stacked with the liquid crystal optical apparatus, the display unit being configured to cause a light including image information to be incident on the liquid crystal layer,
the liquid crystal optical apparatus including:
a first substrate unit including
a first substrate having a first major surface,
a plurality of first electrodes provided on the first major surface, the first electrodes extending in a first direction and being arranged in a second direction orthogonal to the first direction,
a plurality of electrode pairs provided between the first electrodes on the first major surface, the electrode pairs being arranged in the second direction, each electrode pair including
a second electrode extending in the first direction,
a third electrode extending in the first direction, and
an insulating layer provided between the second electrode and the third electrode,
the second electrode and the third electrode being overlapped partly each other when projected onto a plane parallel to the first substrate;
a second substrate unit including
a second substrate having a second major surface opposing the first major surface, and
an opposing electrode provided on the second major surface; and
a liquid crystal layer provided between the first substrate unit and the second substrate unit,
a first distance along the second direction from a position of a first pair of the electrode pairs to a position of a second pair most proximal to the first pair and disposed between the first pair and one electrode of two most proximal first electrodes being shorter than a distance along the second direction from a central axis between the first electrodes to the position of the first pair, the central axis being parallel to the first direction to pass through a midpoint of a line segment connecting centers of the two most proximal first electrodes in the second direction.
